(19) United States
(12) Patent Application Publication
(10) Pub. No.: US 2012/0203628 A1
(43) Pub. Date: Aug. 9, 2012

(54) DYNAMIC AIRPORT ADVERTISEMENT SYSTEM

(76) Inventor: Ralph DeCaro, Harrisonville, NJ (US)

(21) Appl. No.: 13/022,593

(22) Filed: Feb. 7, 2011

(51) Int. Cl. G06Q 30/00

(52) U.S. Cl. 705/14.49

(57) ABSTRACT

A system, method, and computer readable storage to implement dynamic advertising at airport gates. Electronic output devices at airport gates can display advertisements targeted to particular destination cities that travelers at that particular gate are traveling to. The advertisements are not limited to the particular city that the next flight is arriving at, but can (by accessing computer databases) determine cities that passengers are ultimately traveling to and display messages targeted to those cities.

### BACKGROUND OF THE INVENTION

1. Field of the Invention

The present general inventive concept is directed to a method, apparatus, and computer readable storage to implement an improved system for advertising at airport gates.

2. Description of the Related Art

Airports commonly have televisions located at gates so that passengers who are waiting for their flights to depart can enjoy watching television. Advertisements can also be shown on these televisions, however such advertisements are chosen by the television networks and have no nexus to the current airport gate.

What is needed is an airport advertising system that uses real time information known about the passengers waiting at a particular gate in order to present targeted advertisements to these passengers while they are waiting for their flight.

### SUMMARY OF THE INVENTION

It is an aspect of the present invention to provide a method, system, and computer readable storage medium for targeted advertisements at an airport gate to passengers particular destinations.

The above aspects can be obtained by a method that includes (a) providing an electronic output device at an airport gate; (b) determining ultimate destinations for a plurality of passengers using an electronic database, the passengers departing on a next flight at the gate; (c) retrieving targeted advertisements for the ultimate destinations; and (d) displaying the targeted advertisements on the electronic output device.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a block diagram of an airport advertisement system, according to an embodiment;

FIG. 2 is a flowchart of an exemplary method to implement an airport advertising method displaying advertisements for a flight's destination, according to an embodiment;

FIG. 3 is a flowchart of an exemplary method to implement an airport advertising method displaying advertisements for a flight's destination and intermediate stops, according to an embodiment;

FIG. 4 is a flowchart of an exemplary method to implement a method to implement an airport advertising method displaying advertisements for passengers' ultimately destinations, according to an embodiment;

FIG. 5 is a drawing of sample targeted advertisements on an electronic output device, according to an embodiment;

FIG. 6 is a block diagram of an advertising purchasing system, according to an embodiment; and

FIG. 7 is a block diagram illustrating sample hardware that can be used to implement any computer/server described or required herein.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a method, apparatus, and computer readable storage medium to implement an improved airport advertising paradigm. Currently, when travelers are waiting for the flight at an airport gate, they may be presented with television monitors by the airport showing television programming for the enjoyment of the passengers while they pass the time. However, these passengers are a “captive audience” and it would be advantageous from a business perspective to display advertising to these passengers.

It is well known that targeted advertisements are more effective than random advertisements. Advertisements can be presented to the passengers at a particular gate which can be targeted to the passengers' destination. The advertisements can be presented on additional video monitors that can be located at each gate in public view of waiting areas (where there are chairs, etc.) Advertisements can be presented for businesses located in particular destinations. For example, if a flight from New York to Las Vegas is departing from gate A1 at a particular airport, then monitors at gate A1 can display advertisements particular to Las Vegas. For example, the advertisements can be for hotels in Las Vegas, restaurants in Las Vegas, advertisements for the city of Las Vegas in general, etc. Since these travelers are headed to Las Vegas, they would benefit by seeing advertisements targeted for that particular city.

Flights commonly have multiple stops, for example the flight from New York to Las Vegas can continue to Los Angeles which would be its final destination. Thus, advertisements displayed at gate A1 could be targeted for both Las Vegas and Los Angeles, since some passengers will likely get off at Las Vegas and some passengers will likely continue on to Los Angeles.

In addition, air travel passengers commonly have lay-overs where they fly to another city and then change planes and take a further flight to their ultimate destination. The inventive concept described herein can display targeted advertisements in an airport gate targeted to a particular gate's next flight's destination, the gate's flight's continuing destinations, and the ultimate destinations of the gate's flight's passengers. For example, if a particular flight from New York to Las Vegas has a number of passengers changing planes in Las Vegas and travelling on to San Diego, advertisements can be displayed at the gate targeted to San Diego. In the latter situation, the advertising system would be able to check databases in order to discern where a flight's passengers are ultimately ending up (or are likely to end up) to ads for those cities can be displayed.

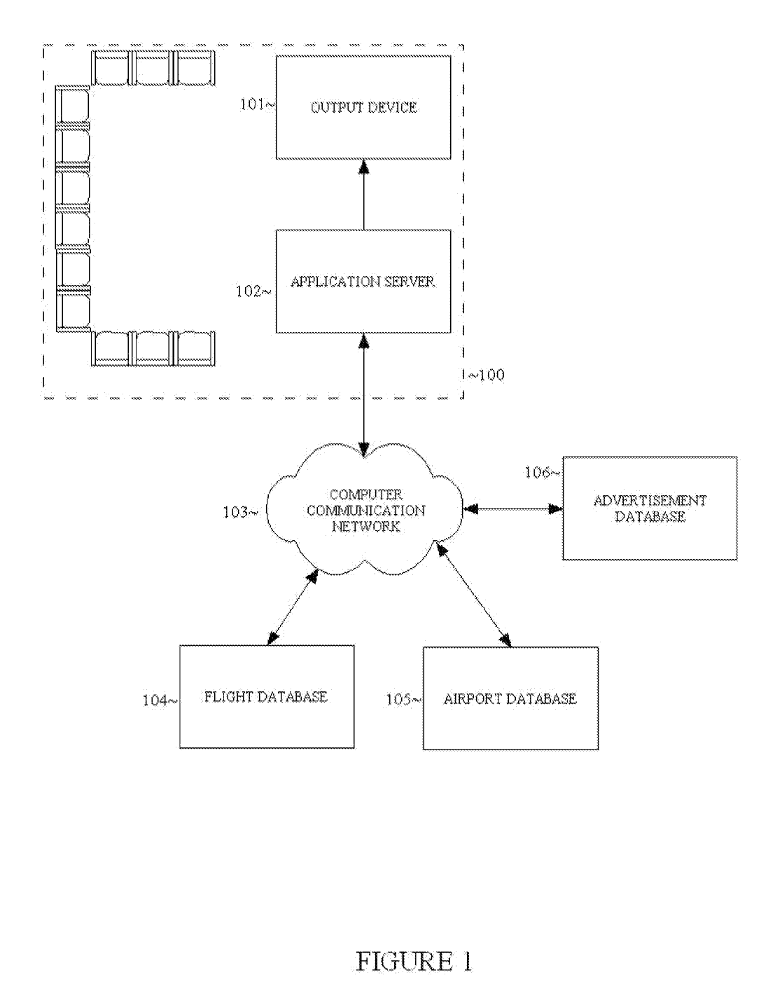

In a preferred embodiment of the system described herein, all (or most) gates at an airport will have their own respective electronic output device which displays ads as described herein. The system can be used at any number of airports throughout the country. FIG. 1 is a block diagram of an airport advertisement system, according to an embodiment.

An airport gate 100 is a place where passengers at an airport gather to board their flight. An airport typically has numerous gates. At the gate 100 an output device 101 is used to display targeted advertisements. The output device 101 (e.g., LCD, Plasma display, CRT, etc.) is driven by an application server 102 which determines the targeted advertisements to be displayed on the output device 101. The application server 102 determines the targeted advertisements using a computer communications network 103 (such as the Internet, a LAN, WAN, wifi, etc.) and accessing a flight database 104 and/or an airport database 105.

The airport database 105 is a database that stored particular flights (identified by flight number or other identifier), each flight's departure time/date, and the gate at the airport that flight will depart from. In this way the application server (which would know which gate each output device is located in) can determine which particular flight is the next flight for each gate in order to select the appropriate advertisements.

The flight database 104 is a database that has information regarding flights, such as each flights' itinerary (all stops and final destination are stored and accessible). The flight database 104 can also store each passenger's itinerary, e.g., their next flight and all of the respective passenger's connecting flights. The application server 102 can query the databases and determine, for the passengers waiting in the gate at a particular time, where they are going.

An advertisement database 106 stores advertisements for different locations. The stored advertisements can include text, graphics, multimedia files (e.g., AVI, etc.) and any other assets required to display targeted advertisements on the output device 101. The application server 102 can request advertisements for particular locations from the advertisement database 106, so the advertisements for these locations can be displayed on the output device 101.

It is noted that while the flight database 104, airport database 105, and advertisement database 106 are illustrated as separate databases, it can be appreciated by one of ordinary skill in the art that these databases can be the same database or that the information needed therein can be spread across more than three databases. The databases can physically exist locally at the airport or can be located at different locations.

In a simplest embodiment, advertisements can be displayed based on a gate's next flight's immediate destination.

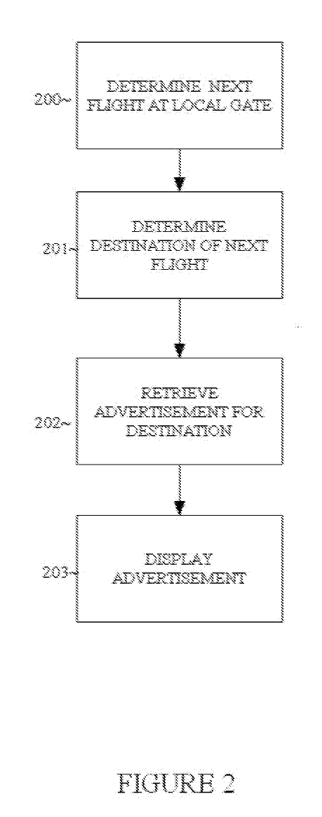

FIG. 2 is a flowchart of an exemplary method to implement an airport advertising method displaying advertisements for a flight's destination, according to an embodiment.

The method can begin with operation 200, which determines the next flight for a particular gate, the gate being associated with an output device. This can be accomplished by querying an airport database.

From operation 200, the method proceeds to operation 201, which determines the destination of the next flight determined in operation 200. The destination can be determined from the airport database or another database. This destination should be the same as the destination that would be displayed at a desk at the gate which shows the next flight's flight number and destination.

From operation 201, the method proceeds to operation 202 which retrieves advertisements from the advertisement database for the destination determined from operation 201. The application server now knows which destination it needs advertisements for and so now it can send the query to the advertisement database.

From operation 202, the method proceeds to operation 203 which displays the advertisement retrieved in operation 202 on the output device referred to in operation 200. Typically, multiple advertisements will be retrieved in operation 202 and the multiple advertisements can be sequentially scrolled on the output device, thereby displaying all or the advertisements to the passengers waiting at the gate.

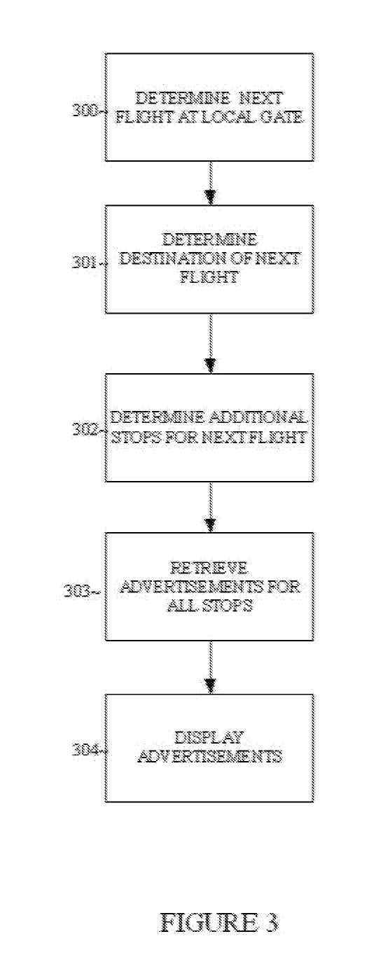

FIG. 3 is a flowchart of an exemplary method to implement an airport advertising method displaying advertisements for a flight's destination and intermediate stops, according to an embodiment.

The method can begin with operation 300, which determines the next flight to leave at a particular gate associated with an output device. This can be done similar to operation 200.

From operation 300, the method proceeds to operation 101, which determines a destination of the next flight from operation 300. This can be done as described in operation 201.

From operation 301, the method proceeds to operation 302, which determines additional stops for the next flight. For example, if the next flight is to Las Vegas but then the same flight (or airplane) continues on to Los Angeles, then Los Angeles would be considered an additional stop.

From operation 302, the method proceeds to operation 303, which retrieves advertisements for all stops for the next flight as determined in operation 302. All stops meaning all cities that the same plane will be landing in that day (e.g., in the above example this would be both Las Vegas and Los Angeles), or alternatively all stops could comprise just the legs the plane stops at that the airline considers to be part of a flight number.

From operation 303, the method proceeds to operation 304 which displays the advertisements retrieved in operation 303 on the output device. In this manner, advertisements are not only displayed for the city the next flight is immediately flying to, but all other cities on the plane's flight schedule for the day.

It would be likely that a good number of passengers taking the next flight (from operation 300) would be destined for any of these cities. If a passenger is flying through a lay-over city to a final destination city, then if advertisements are shown for the lay-over city it would be of no use to the passenger. Thus, the method illustrated in FIG. 3 covers more relevant cities for a flight than the method illustrated in FIG. 2.

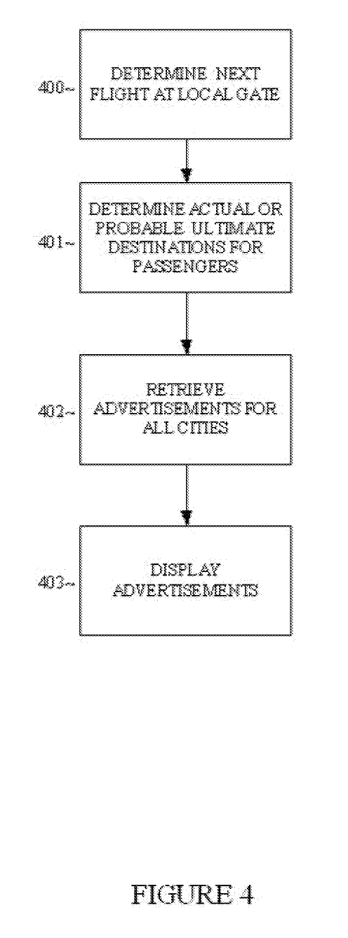

FIG. 4 is a flowchart of an exemplary method to implement a method to implement an airport advertising method displaying advertisements for passengers' ultimately destinations, according to an embodiment.

The method can begin with operation 400, which determines a next flight at a gate associated with an output device. This can be done as described in operation 200.

From operation 400, the method proceeds to operation 401, which determines actual or probably ultimate destinations for the passengers on the next flight. Ultimate destinations are the final city the passenger is traveling to that day (after all the legs of his/her flight(s) are complete). Ultimate destinations for the passengers on the next flight can be ascertained by querying the flight database. Assuming the flight database (or a combination of databases) allows the application server access to the information, the application can server can retrieve the itinerary for each passenger on the next flight. The itinerary would include all additional flights that each passenger would be taking that day (if any). If the next flight is the only flight that day for the passenger, then of course the ultimate destination city is the destination of the next flight. If a passenger has one or more additional flights on his itinerary for the day, then the ultimate destination city is the last destination of all of those flights. In this manner, all of the ultimate destinations for all of the passengers on the next flight can be determined.

From operation 402, the method proceeds to operation 403, which retrieves advertisements targeted for the ultimate destination cities from operation 402.

From operation 402, the method proceeds to operation 403, which displays the advertisements retrieved in operation 402 on the output device(s) at the local gate from operation 400.

Thus, using the method illustrated in FIG. 4, advertisements can be presented to passengers waiting at a gate that are highly targeted to the ultimate destination cities of the passengers on the next flight at that gate. Advertisements are presented which are only targeted for the cities comprising a list of the ultimate destination cities of the passengers at the gate. Thus, for example, consider a flight at a gate is going to St. Louis and then continuing on to Reno, Nev. If all passengers are continuing on to Reno and none are staying in St. Louis, then only ads targeted for Reno would be displayed on the output device. On the other hand, if all of the passengers were getting off at St. Louis, then ads would be displayed only for St. Louis since no passenger at that gate is going to Reno. If some passengers are getting off at St. Louis and some are continuing on to Reno, then advertisements for both St. Louis and Reno would be displayed. If some passengers were getting off at St. Louis, some passengers were getting off at Reno, and other passengers were taking a new (and different) flight from Reno to Sacramento, then advertisements for St. Louis, Reno, and Sacramento can all be displayed on the output device.

Table I below illustrates a sample record of an airport database that lists passengers on a next flight out of a particular gate. Each passenger can also be assigned a unique identification number in order to reference that passenger's records without having an issue from multiple passengers with identical names.

TABLE I
Flight: 1204 from Philadelphia to Houston, Texas,
departing 1:00pm Jan. 5, 2011, gate A31.

| Passengers | ID# |
|---|---|
| Joe Smith | 34989843 |
| Jane Doe | 90943434 |
| Bill Watson | 32433344 |
| . | |
| . | |
| . | |

Table II below illustrates a sample itinerary that can be stored and retrieved on a flight database.

TABLE II
Passenger name: Bill Watson, 32433344

Flight 1: 1204 from Philadelphia to Houston, 1:00pm Jan. 5, 2011
Flight 2: 944 from Houston to Los Angeles, 5pm Jan. 5, 2011
Flight 3: 433 from Los Angeles to Sacramento, 9pm Jan. 5, 2011

A record such as that illustrated in Table II can be stored for each passenger (both their departing and their returning flights). Thus, by accessing a database where a record such as that illustrated in Table I can be retrieved, and then accessing a database where a record such as that illustrated in Table II can be retrieved (for each passenger from the other record), each passengers' ultimate (or final) destination can be ascertained for that day. These ultimate destinations can be used to generate a list (or set) of ultimate destinations which can then be used to determine a list (or set) of targeted advertisements for each of the ultimate destinations which can then be displayed sequentially on an electronic output device at the respective gate (e.g., gate A31 in Table I).

Using data from the databases, a table (such as Table III) can be generated (by application server 102 or other computer) which is a list of all passengers at the particular gate and their ultimate destinations.

TABLE III

| Passengers | ID# | ultimate destination |
|---|---|---|
| Joe Smith | 34989843 | Houston |
| Jane Doe | 90943434 | Houston |
| Bill Watson | 32433344 | Sacramento |
| . | | |
| . | | |
| . | | |

The application server driving the electronic output device can choose to display advertisements targeted for which ultimate destinations and in what frequency. For example, in Table III, if passenger Watson was the only passenger with an ultimate destination of Sacramento, then advertisements may not be displayed for Sacramento considering there is only one passenger going there. Or alternative, advertisements would be displayed for Sacramento. Or advertisements can be displayed in proportion to the frequency of passengers heading for an ultimately destination. For example, in Table III (assuming the three passengers are the only ones on the plane), since two passengers are ultimately heading for Houston and one is ultimately heading for Sacramento, then ⅔ of the advertisements shown on the output device will be targeted (associated) with Houston while only ⅓ of the advertisements shown will be targeted (associated) with Sacramento. Or the same set advertisements can be shown but the amount of time the advertisements are shown is proportional to the number of travelers going therein. For example there can be an ad shown associated with Houston for 10 minutes then an ad shown associated with Sacramento for 5 minutes and then the cycle repeats (until the flight leaves). Thus, the Houston ad is shown for ⅔ of the time while the Sacramento ad is shown for ⅓ of the time, in the same proportion as these cities are the ultimate destinations for passengers.

Thus, as an example of this embodiment, if a flight is leaving from New York at gate C33 to Philadelphia and everyone on the flight is taking a connection that day from Philadelphia to a further destination, then no advertisements would be shown targeted to Philadelphia on the output device(s) located in view of gate C33. Instead, advertisements will be shown which are targeted to the ultimate destinations of travelers on the flight that departed from Philadelphia.

In another embodiment, a less accurate method could be used to determine (or estimate) where passengers at one gate are ultimately destined for. A master database can store all flight information for all flights (e.g., flight #, departure time, departure city, arrival city, arrival time, etc.) The FAA maintains such a database which is publicly accessible, although the same data may be available using other databases as well. For a particular flight soon departing (the current flight) at a gate where an output device is located, the master flight database can be queried to determine where the flight is going. Of course, the output device (in all embodiments) must be associated with a particular gate at the particular airport in the system, so the system knows which output device is located at which gates. Once it is determined where the current flight is going, the database can determine which flights leave from that arrival airport in a close proximity of time to the arrival time (e.g., 90 minutes). If there are not many flights departing at the arrival airport in that period of time, it can be assumed that people on the flight taking connections may probably be on one of these flights. It can also be assumed that at most, passengers have only one or two layovers. Thus, by using such a database of all flights, ultimate destinations (in cases where the arrival airport does not have a lot of good prospects for connections) can be estimated upon. This method would typically not be as accurate as using individual passenger flight data.

An example of the above method is presented. Suppose flight A is departing from New York at 1:00 pm at gate X (where the output device is) and arriving in Harrisburg at 3:00 pm. Harrisburg is a small airport and according to the database, only has two flights leaving from 3:00 pm to 5:00 pm (using a 2 hour differential, although other differentials can be used): flight B from Harrisburg to Los Angeles at 4:00 pm and flight C from Harrisburg to Charlotte at 4:30 pm. Flights departing from Harrisburg after 5:00 pm (using the 2 hour differential are not considered). The system can surmise that passengers on flight A are ultimately going to either Harrisburg (not connecting), Los Angeles, or Charlotte. It may be that some passengers to the latter two cities will be connecting again, but those are not considered. The output device at gate X can now show advertisements for Harrisburg, Los Angeles, and Charlotte. While the system does not know with certainty that passengers on flight A (and hence waiting at gate X for the flight leave) are ultimately going to Los Angeles or Charlotte, the system concludes there is a high likelihood of this.

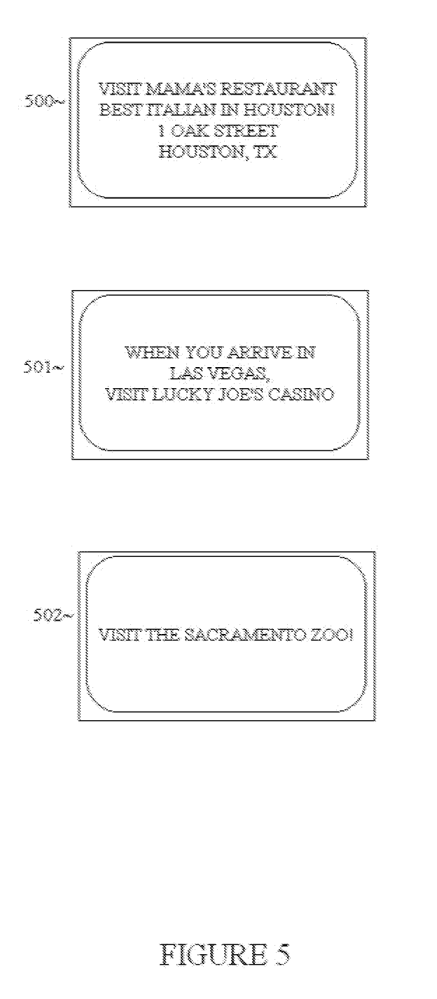

FIG. 5 is a drawing of sample targeted advertisements on an electronic output device, according to an embodiment.

First advertisement 500 promotes a restaurant in a city in (Houston) in which some travelers at a particulate gate are ultimately travelling to. Second advertisement 501 promotes a business in a city that some travelers at a particular gate are traveling to. Third advertisement 502 promotes a public activity by a city itself (Sacramento) hoping that the passengers waiting at the gate who are ultimately traveling to Sacramento will visit their zoo. Each targeted advertisement can be shown on the electronic output display for a predetermined amount of time (e.g., 20 seconds) before changing to a new targeted advertisement.

Advertisements can be sold to advertisers using an online system. Advertisers can pay a fixed cost each time their advertisement is shown, or they can bid among other advertisers for ad space.

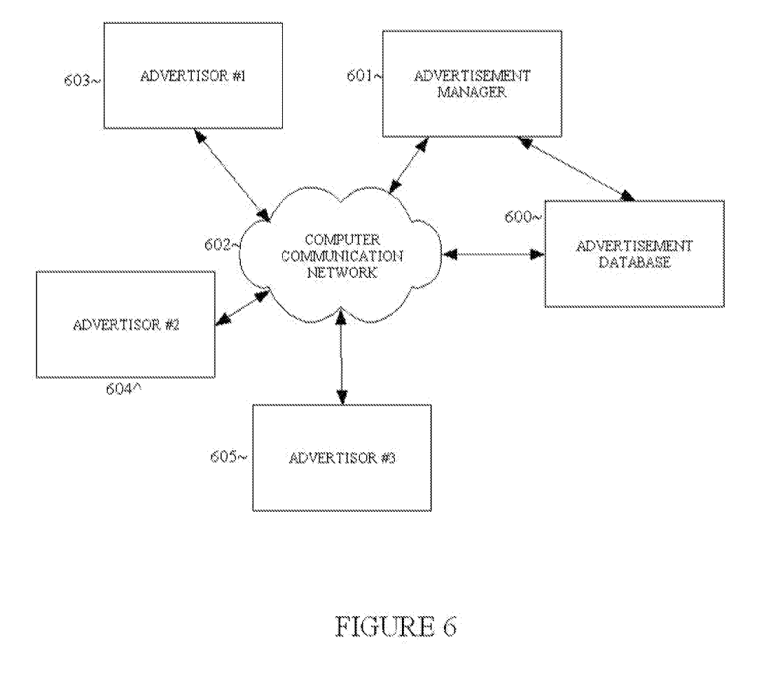

FIG. 6 is a block diagram of an advertising purchasing system, according to an embodiment.

An advertisement database 600 (also can serve as advertisement database 106 can store ads (advertisements). Each ad can be associated with a different city. An advertisement manager 601 is an electronic server that receives ad requests from a plurality of different advertisers and sells them the ability for their advertisements to be displayed on the electronic output devices at airport gates.

Different advertisers (including advertiser 1 603, advertiser 2 604, advertise 3 605) can have businesses located in the same or different cities from each other. They would all access the advertisement manager 601 using a computer communications network 602 such as the Internet. They could use a web browser (or other client/server platform) in order to interact with the advertisement manager 601 in order to purchase advertising space on the output devices.

For example, advertiser 1 603 owns a restaurant (or any other business) in Philadelphia. He connects to the advertisement manager 601 and arranges to purchase 100 showings of his or her advertisement when gates have a flight with passengers ultimately heading to Philadelphia. Advertiser 1 603 would also draft his or her advertisement (in text or graphic form) and transmit the advertisement to the advertisement manager 601. All advertisements would be stored on the advertisement database 600 which would also serve the advertisements to the application server (see FIG. 1) using a computer communications network.

Instead of a fixed price per advertisement, advertisements can also bid on ad space. For example, all businesses that have advertisements to be associated with Philadelphia can compete with each other in a virtual auction (hosted by the advertisement manager 601) so that the highest bidder for ad space (price per ad showing) will win the showings. Alternatively, space can be sold on a temporal basis (e.g., hourly, daily) and advertisers can compete with each other in an auction for the right to have their business shown as the only ad for that location for a predetermined period of time (e.g., advertiser 3 605 pays a fixed $1,000 to have only his ads for his Houston restaurant shown all day at all gates with a passenger ultimately heading to Houston).

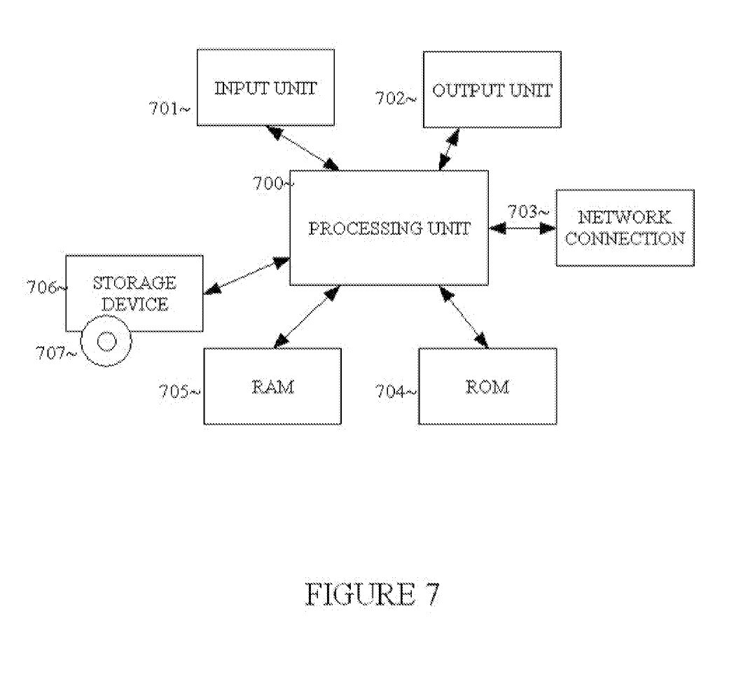

FIG. 7 is a block diagram illustrating sample hardware that can be used to implement any computer/server described or required herein.

A processing unit 700 is a microprocessor and any associated structure (e.g., bus, cache, etc.) which can be connected to an input device (e.g., keyboard, mouse, touch-screen, etc.) and an output device (e.g., CRT, LCD, etc.) The processing unit 700 is also connected to a network connection 703 which can connect to a computer communications network (e.g., Internet, wifi, LAN, WAN, etc.) The processing unit 700 is also connected to a ROM 704 and a RAM 705 and a computer readable storage reader/writer 706 that can read/write to a computer readable storage medium 707 (e.g., BLU-RAY, DVD-ROM, CD-ROM, EPROM, floppy disk, hard disk, etc.) The storage medium 707 and/or ROM can also store instructions to control the processing unit to implement any method required by the computer, including (but not limited to) those operations described herein.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer. While operations described herein may be described as taking place on single computer, server, or database, it can be appreciated that any set of operations can be spread apart any number of different physical computers, servers, or databases. In addition, while some operations described herein may be described as taking place on different computers, servers, or databases, it can be appreciated that such operations can also take place on a single computer, server, or database.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method for delivered targeted messages at an airport gate, the method comprising:
providing an electronic output device at an airport gate;
determining ultimate destinations for a plurality of passengers using an electronic database, the passengers departing on a next flight at the gate;
retrieving targeted advertisements for the ultimate destinations; and
displaying the targeted advertisements on the electronic output device.

2. The method as recited in claim 1, wherein the ultimate destinations are determined using the next flight's final destination.

3. The method as recited in claim 1, wherein the electronic database comprises a flight database which stores an itinerary for each passenger on the next flight, and the ultimate destinations comprise a last flight for the same day on each respective itinerary for each passenger on the next flight.

4. The method as recited in claim 1, wherein the targeted advertisements are retrieved from an advertisement database, wherein advertisers sponsoring each of the targeted advertisements have won bids to have their respective advertisements displayed.

5. The method as recited in claim 1, wherein for each time a targeted advertisement is shown on the output device a sponsor of the targeted advertisement is charged a monetary amount.

6. An apparatus to deliver targeted messages at an airport gate, the apparatus comprising:
an electronic output device located at an airport gate;
an application server connected to the electronic output device, the application server programmed to perform:
determining ultimate destinations for a plurality of passengers using an electronic database, the passengers departing on a next flight at the gate;
retrieving targeted advertisements for the ultimate destinations; and
displaying the targeted advertisements on the electronic output device.

7. The apparatus as recited in claim 6, wherein the ultimate destinations are determined using the next flight's final destination.

8. The apparatus as recited in claim 6, wherein the electronic database comprises a flight database which stores an itinerary for each passenger on the next flight, and the ultimate destinations comprise a last flight for the same day on each respective itinerary for each passenger on the next flight.

9. The apparatus as recited in claim 6, wherein the targeted advertisements are retrieved from an advertisement database, wherein advertisers sponsoring each of the targeted advertisements have won bids to have their respective advertisements displayed.

10. The apparatus as recited in claim 6, wherein for each time a targeted advertisement is shown on the output device a sponsor of the targeted advertisement is charged a monetary amount.
